(19) United States
(12) Patent Application Publication
(10) Pub. No.: US 2006/0102437 A1
(43) Pub. Date: May 18, 2006

(54) Brake system of working machine

(76) Inventors: Masato Nara, Tokyo (JP); Hiroyuki Miyaki, Tokyo (JP); Kenji Nakano, Tokyo (JP)

Correspondence Address: Michael D. Bednarek;Pillsbury Winthrop Shaw Pittman LLP, 1650 Tysons Boulevard, McLean, VA, 22102, US

(21) Appl. No.: 11/250,400

(22) Filed: Oct. 17, 2005

(30) Foreign Application Priority Data
Nov. 17, 2004 (JP) 2004-333553

(51) Int. Cl. F16D 51/00

(52) U.S. Cl. 188/77 R

(57) ABSTRACT

A brake system of a working machine includes a brake connector for operatively connecting between a brake lever and a braking member, and an urging member that maintains the brake lever at a predetermined neutral position and also acts to return the brake lever to the predetermined neutral position when the brake lever is displaced from the predetermined neutral position. When the brake lever is located at the predetermined neutral position, the brake lever and the brake connector are out of contact with each other.

### BACKGROUND

1. Field of the Invention

The present invention relates to a brake system of a working machine.

2. Background of the Invention

When a hand-held working machine, such as a chain saw, is operated to cut trees by being driving at a high speed, the chain saw may produce a reaction referred to as a kickback phenomenon. For example, if the chain saw is inadvertently brought into contact with a tree knot, a kickback phenomenon may be produced such that the chain saw itself may be flung toward an operator. To protect operators from the chain saws during the kickback phenomenon, proposals have been made to use various types of brake system capable of urgently stopping the rotation of the chain saw.

An example of such a brake system is disclosed in U.S. Pat. No. 4,586,588. This brake system includes a pivotable member (brake connector) that operatively connects a brake lever, which serves also as a front-hand guard, to a brake band that is a brake member.

During normal operation of the chain saw, the brake lever is held out of contact with the pivotable member. The brake lever maintains a non-contact neutral state with a click stop mechanism, which requires fine components, during the normal operation.

The above-mentioned conventional brake system has advantages in that vibration due to an internal combustion engine for driving the chain saw is not transmitted between the brake lever and the brake connector during normal operation so as to eliminate fluttering noise produced therebetween.

However, a disadvantage to this brake system is that an operator must return the brake lever to the neutral position by visual observation of a neutral position indicator marked on the surface of the chain saw. Thus, it is desired to increase the operating efficiency by returning the brake system to a neutral position.

### BRIEF SUMMARY OF THE INVENTION

The present invention has been made in view of the situation mentioned above, and it is an object thereof to provide a braking system of a working machine having the same advantages as those of the above-mentioned conventional brake system and with further improved efficiency of operation being capable of securely returning to the neutral position without any attention to the brake lever.

A brake system of a working machine according to the present invention includes a braking member for braking an operating member mounted on a working machine body; a brake lever for operating the braking member; a brake connector for operatively connecting the brake lever to the braking member; an urging member that maintains the brake lever at a predetermined neutral position and constantly acts to return the brake lever to the predetermined neutral position if the brake lever is displaced from the predetermined neutral position; and a locking mechanism operated by the displacement of the brake connector so as to maintain the braking member in a braked state or in a brake-cancelled state. When the brake lever is located at the predetermined neutral position, the brake lever and the brake connector are out of contact with each other, and by the displacement of the brake lever in a braking direction from the predetermined neutral position, the brake connector is driven in one direction and by the locking mechanism, the braking member is maintained in the braked state, while by the displacement of the brake lever in a brake-canceling direction, the brake connector is driven in the other direction and by the locking mechanism, the braking member is maintained in the brake-cancelled state.

According to this configuration, during the normal operation of the working machine, the brake lever is held at the neutral position by the urging member, and the braking member is in a brake-cancelled state not braking the operating member in accordance with this while the brake lever and the brake connector are out of contact with each other. Accordingly, even when the working machine body vibrates due to the operation of the working machine, fluttering noise cannot be produced between the brake lever and the brake connector.

When the brake lever is displaced in a braking direction from the predetermined neutral position, the brake connector is driven in one direction and by the locking mechanism, the braking member is maintained in the braked state.

On the other hand, when an operator shifts the brake lever in a brake-canceling direction, the brake connector is driven in the other direction, and by the locking mechanism, the braking member is maintained in a brake-cancelled state. When the operator loses one's grip on the brake lever after displacing the brake lever in the brake-canceling direction, by the function of the urging member, the brake lever is automatically returned to the predetermined neutral position. Therefore, the operator is not required to confirm whether the brake lever returns to the predetermined neutral position or not by visual observation, improving operationality.

According to a preferred embodiment, the urging member may be a torsion spring arranged about the swinging center of the brake lever. Thus, the arrangement space for the urging member can be reduced as small as possible, enabling the machine to be compact.

According to the preferred embodiment, the working machine body may include a first member and a second member attached to the first member, and preferably the brake lever is swingably attached to the first member; the urging member is interposed between the first member and the brake lever; and the braking member and the brake connector are assembled to the second member. Thus, when the brake lever is located at the predetermined neutral position, the brake connector is out of contact with the brake lever, so that the second member having the brake connector attached thereto can be easily and preferably put on and taken off the first member having the brake lever attached thereto.

In this case, the first member may also be a frame for an internal combustion engine; the operating member may include a centrifugal clutch drivingly connected to the internal combustion engine; and the second member may include a centrifugal clutch cover.

According to another preferred embodiment, the working machine body may include a first member and a second member attached to the first member, and preferably the brake lever is swingably attached to the second member; the urging member is interposed between the second member and the brake lever; and the braking member and the brake connector are assembled to the first member.

In this case, the first member may further include a crankcase of an internal combustion engine and the second member may include a cover of the locking mechanism.

According to the preferred embodiment, the locking mechanism may be an over dead center mechanism interposed between the brake connector and the braking member.

### BRIEF DESCRIPTION OF THE DRAWINGS

FIG. 1 is a perspective view of an entire chain saw as a working machine having a brake system according to the embodiment of the present invention;

FIG. 2 is a partially broken side view of a brake-cancelled state of the brake system according to the embodiment shown in FIG. 1;

FIG. 3 is a partially broken side view of a braked state of the brake system shown in FIG. 2;

FIG. 4 is a partially broken side view of a brake-canceling state of the brake system shown in FIG. 2;

FIG. 5 is an exploded perspective view showing a brake lever mounting structure of the brake system shown in FIG. 2;

FIG. 6 is an exploded perspective view of a locking mechanism of the brake system shown in FIG. 2;

FIG. 7 is a perspective view showing an assembling state of FIGS. 5 and 6;

FIG. 8 is a partially broken side view of a brake-cancelled state of a brake system according to another embodiment of the present invention;

FIG. 9 is a partially broken side view of a braked state of the brake system shown in FIG. 8;

FIG. 10 is a partially broken side view of a brake-canceling state of the brake system shown in FIG. 8; and

FIG. 11 is an exploded perspective view showing a brake lever mounting structure of the brake system shown in FIG. 8.

### DETAILED DESCRIPTION OF THE INVENTION

A brake system according to an embodiment of the present invention and incorporating a chain saw as a typical working machine will be described below.

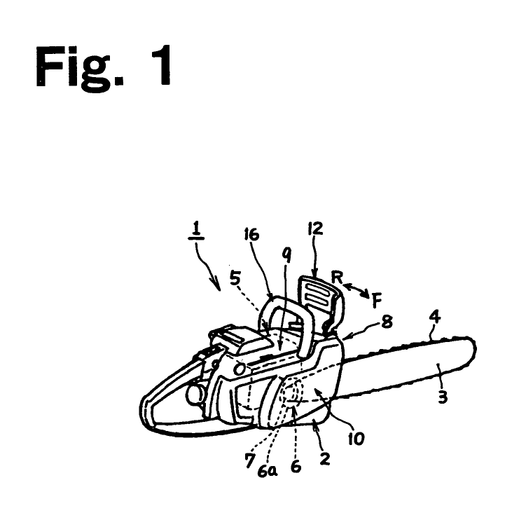

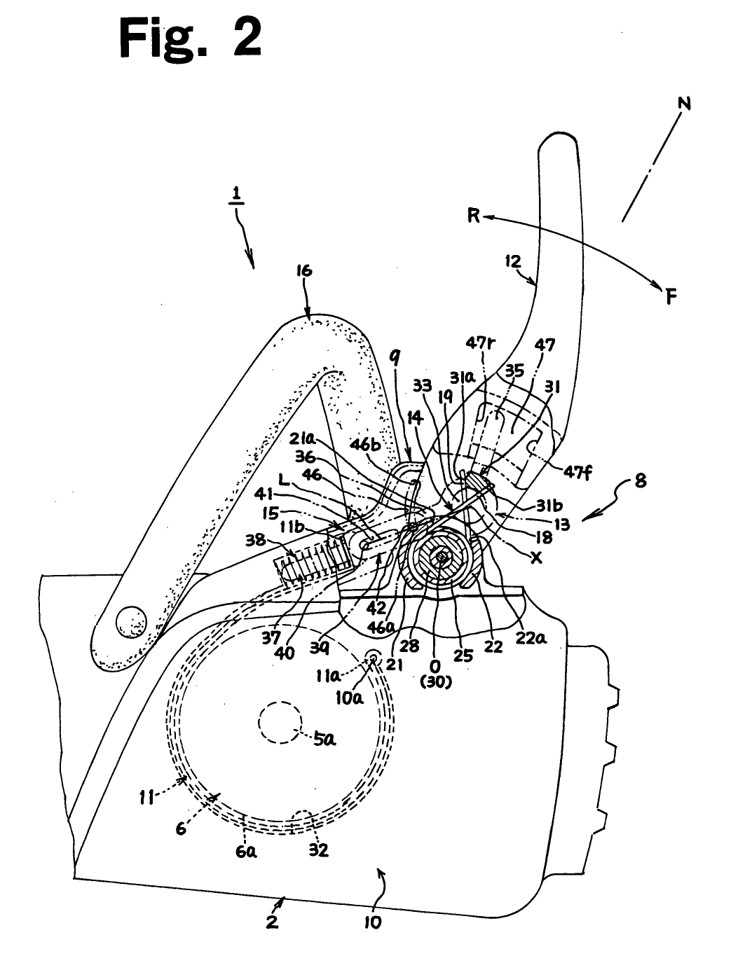

Referring to FIG. 1, a chain saw body 2 of a chain saw I includes an internal combustion engine 5, such as a compact air-cooled two-stroke cycle engine, for driving a saw chain 4 to run along the external periphery of a guide bar 3 extending along the front-rear direction of the machine. The output shaft (see FIG. 2) 5a of the internal combustion engine 5 includes a sprocket 7 connected thereto with a centrifugal clutch 6 as a working member therebetween for looping the saw chain 4 therearound. According to the embodiment, outside the centrifugal clutch 6 and opposite to the internal combustion engine 5, the sprocket 7 is coaxially fixed to a clutch drum 6a of the centrifugal clutch 6. Hence, by braking the clutch drum 6a with a brake system 8 according to the embodiment, the chain saw 4 can be forcedly stopped. The internal combustion engine 5 is attached to a frame 9 integrally having tanks for chain oil and fuel if necessary as a first member of the chain saw body 2. On an extension wall of the frame 9 adjacent to the output of the engine, a centrifugal clutch cover 10 is detachably attached as a second member of the chain saw body 2.

As shown in FIG. 2, the brake system 8 includes a brake band 11 as a brake member, a brake lever 12 for operating the brake band 11, a brake connector 13 for connecting the brake lever 12 to the brake band 11, a lever spring 14 for holding the brake band 11 at a predetermined neutral position N shown in FIG. 2 as an urging member, and a locking mechanism 15 for holding the brake band 11 in a braked state and in a brake-cancelled state.

According to the embodiment, the brake lever 12 and the lever spring 14 are attached to the frame 9 for the engine, and residual members, i.e., the brake band 11, the brake connector 13, and the locking mechanism 15, may be assembled on the internal surface of the centrifugal clutch cover 10. Upon assembling the chain saw 1, to the frame for the engine 9, the lever spring 14 and the brake lever 12 are attached while to the centrifugal clutch cover 10, the brake band 11, the brake connector 13, and the locking mechanism 15 are fixed. Then, the centrifugal clutch cover 10 is covered on the frame for the engine 9 so as to complete the assembling, enabling the assemble to be simply performed.

Next, the brake lever 12 and the lever spring 14 will be described.

The brake lever 12 is supported to the frame for the engine 9 in a manner that allows it to swing in the front-rear direction F-R. Under normal conditions, brake lever 12 is held at the predetermined neutral position N shown in FIG. 2 so as to also serve as a front-hand guard. According to the embodiment, the predetermined neutral position N is assumed to be the state shown in FIG. 2 wherein the brake lever 12 is naturally raised in front of a front handle 16 of the chain saw 1.

The lever spring 14 maintains the brake lever 12 at the predetermined neutral position N as well as acts to automatically return the brake lever 12 to the predetermined neutral position N always when the brake lever 12 is swung in the front-rear direction F-R of the chain saw 1 from the predetermined neutral position N.

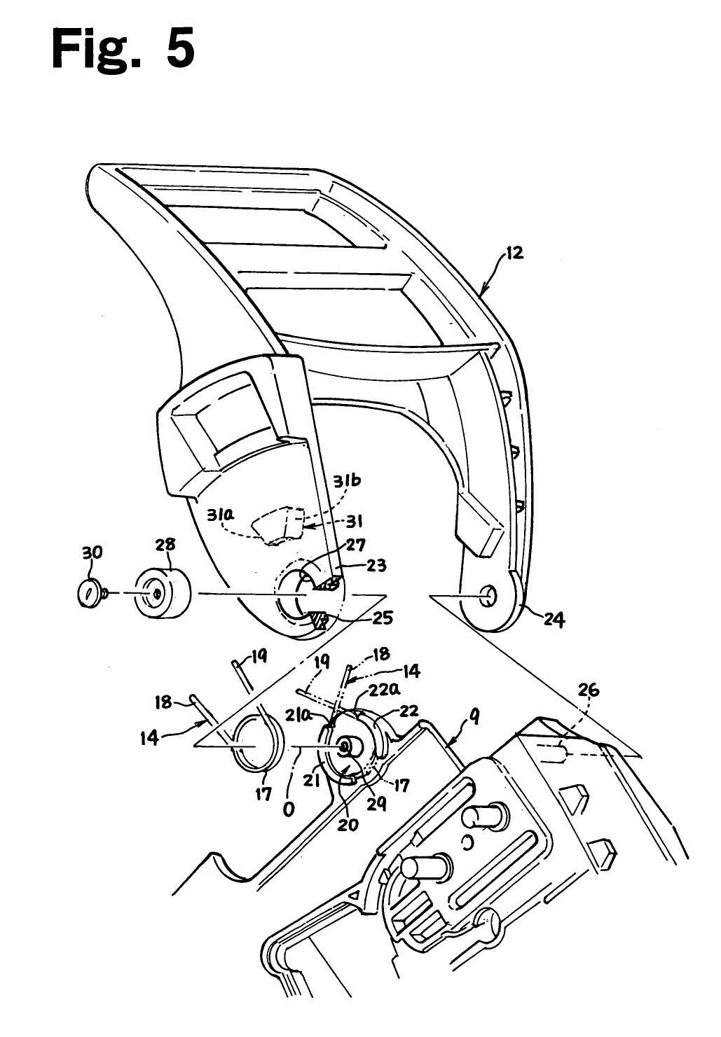

As shown in FIG. 5, according to the embodiment, a torsion spring is used for the lever spring 14, and this torsion spring is arranged between the side face of the frame for the engine 9 adjacent to the output of the engine and the brake lever 12 coaxially with the swinging center O of the brake lever 12. Thus, the arrangement space for the lever spring 14 can be reduced as small as possible, enabling the machine to be compact.

The torsion spring 14 includes a wound ring portion 17 and two angular portions 18 and 19 disposed at both ends of the wound ring portion 17, each broadening toward its end before being attached. As shown in FIG. 5 with phantom lines, the spring is held to have a posture corresponding to the predetermined neutral position N by crosswise gathering the two angular portions 18 and 19 so as to be fitted into an intrusion portion 20 formed in the frame for the engine 9 in a state that a springing force is stored. The spring intrusion portion 20 includes a pair of arc projections 21 and 22 opposing each other and curved in shapes corresponding to the ring portion 17. Upper ends 21a and 22a of the respective pair of arc projections 21 and 22 define restriction portions of the two angular portions 18 and 19 when the lever spring 14 is held to have a spring posture on normal conditions. That is, when the ring portion 17 is fitted between the pair of arc projections 21 and 22 by gathering the two angular portions 18 and 19 together, which are opened before being attached, the two angular portions 18 and 19 abut the restriction portions 21a and 22a, respectively, by the springing force of the torsion spring 14, so that the restriction portions 21a and 22a restrict the further opening of the two angular portions 18 and 19. When the torsion spring 14 is held to have a spring posture on normal conditions, as shown in phantom lines of FIG. 5, the two angular portions 18 and 19 are intersected with each other.

After fitting the torsion spring 14 into the spring intrusion portion 20, the brake lever 12 is attached thereon. The brake lever 12 includes two right-and-left legs 23 and 24 for attaching the brake lever 12 to the frame for the engine 9. The brake lever 12 is provided with a cylindrical projection 25 integrally formed coaxially with the spring intrusion portion 20 on the internal surface of the leg 23, which is located adjacent to the spring intrusion portion 20. The cylindrical projection 25 acts as a spring intrusion portion of the brake lever 12 and has an external surface with a size just fitting the internal surface of the ring portion 17. Hence, after fitting the torsion spring 14 into the spring intrusion portion 20, when the other leg 24, from thereon, is brought into engagement with an engagement portion 26 formed on the other side of the frame for the engine 9, and the one leg 23 is coaxially overlapped thereon, the cylindrical projection 25 is fitted into the internal surface of the ring portion 17. Then, from the outside of the one leg 23, by attaching an anti-slipping cylinder 28 rotatably fitting into a through hole 27 formed coaxially with the cylindrical projection 25 and a mounting screw 30 inserted into the anti-slipping cylinder 28 and screwed into a screw hole 29 formed at the center of the spring intrusion portion 20 to the one leg 23, the torsion spring 14 is clamped between the frame for the engine 9 and the brake lever 12, and the mounting of the brake lever 12 on the frame for the engine 9 in a manner that allows it to swing in the front-rear direction is completed.

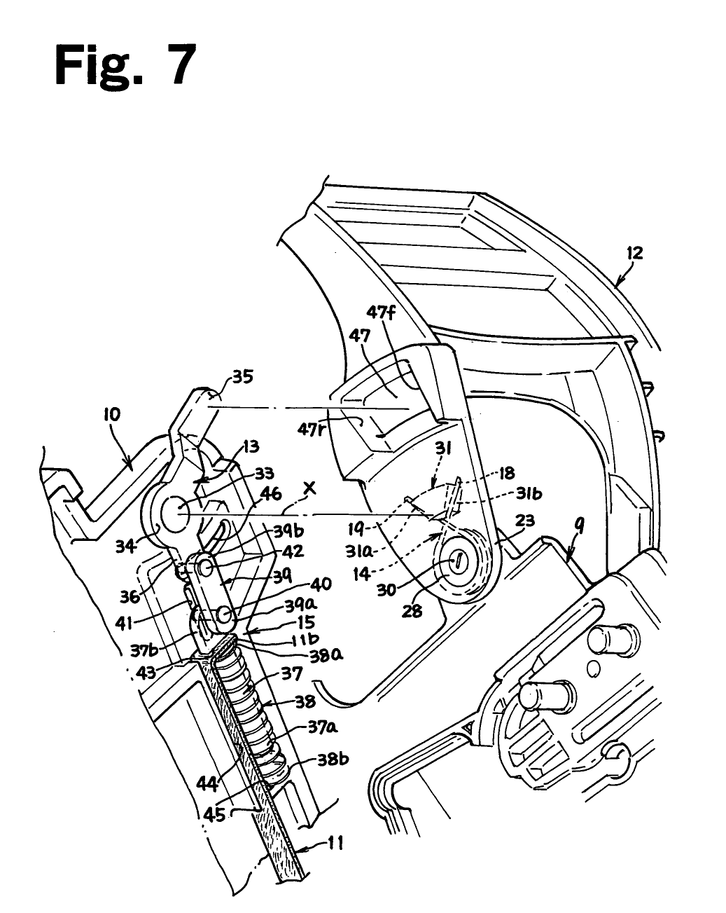

The brake lever 12 is provided with a spring receiving portion 31 formed to be joined on the two angular portions 18 and 19 of the torsion spring 14. The brake lever 12 is attached to the frame for the engine 9 at an angular position (the predetermined neutral position N), at which the torsion spring 14 having the spring posture on normal conditions is finely joined to the spring receiving portion 31. The spring receiving portion 31 is formed to protrude at a position slightly higher than the cylindrical projection 25 on the internal surface of the one leg 23. Two front-rear spring receiving surfaces 31a and 31b of the spring receiving portion 31, which are opposite one another, abut the torsion spring 14 at end portions separated from the intersection of the two angular portions 18 and 19, respectively (see FIG. 7). Accordingly, the torsion spring 14 maintains the brake lever 12 at the predetermined neutral position N such that when a hand is freed after displacing the brake lever 12 in the front-rear direction F-R of the handle 16 from the predetermined neutral position N, torsion spring 14 acts to automatically return the brake lever 12 to the predetermined neutral position N. In contrast to the above-description, using the cylindrical projection 25 and the spring receiving portion 31, at first, the torsion spring 14 is attached to the brake lever 12 in the spring posture on normal conditions, and then, the brake lever 12 in this state may be obviously attached to the centrifugal clutch cover 10.

Next, members attached to the centrifugal clutch cover 10, namely the brake band 11, the brake connector 13, and the locking mechanism 15, will be described.

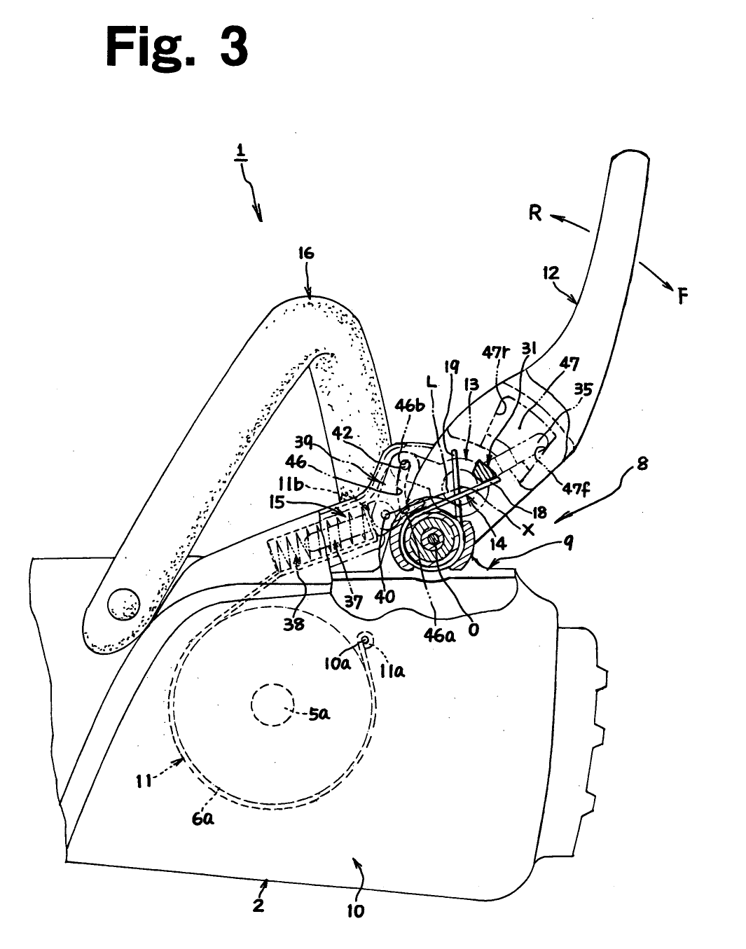

As shown in FIG. 2, the brake band 11 is wound around the external surface of the clutch drum 6a, with one end 11a joined on the internal surface of the centrifugal clutch cover 10 with a retainer pin 10a and with the other end 11b operatively connected to the brake connector 13 via the locking mechanism 15. On the internal surface of the centrifugal clutch cover 10, a cylindrical clutch drum accommodating recess 32 is formed to correspond to the clutch drum 6a, and the brake band 11 is arranged along the internal surface of the clutch drum accommodating recess 32 so as to be slightly press-bonded thereon. Thus, when the centrifugal clutch cover 10 is attached to the frame for the engine 9, between the external surface of the clutch drum 6a and the internal surface of the clutch drum accommodating recess 32, the brake band 11 is naturally located slightly apart from the external surface of the clutch drum 6a. When the brake lever 12 is located at the predetermined neutral position N, the brake band 11 is in a brake-cancelled state in that the clutch drum 6a is not braked. By the swinging of the brake lever 12 in the brake operating direction on the right F of FIG. 2 (in front of the chain saw 1) due to the kickback phenomenon, as shown in FIG. 3, the state is changed to the braking to be press-bonded on the external surface of the clutch drum 6a.

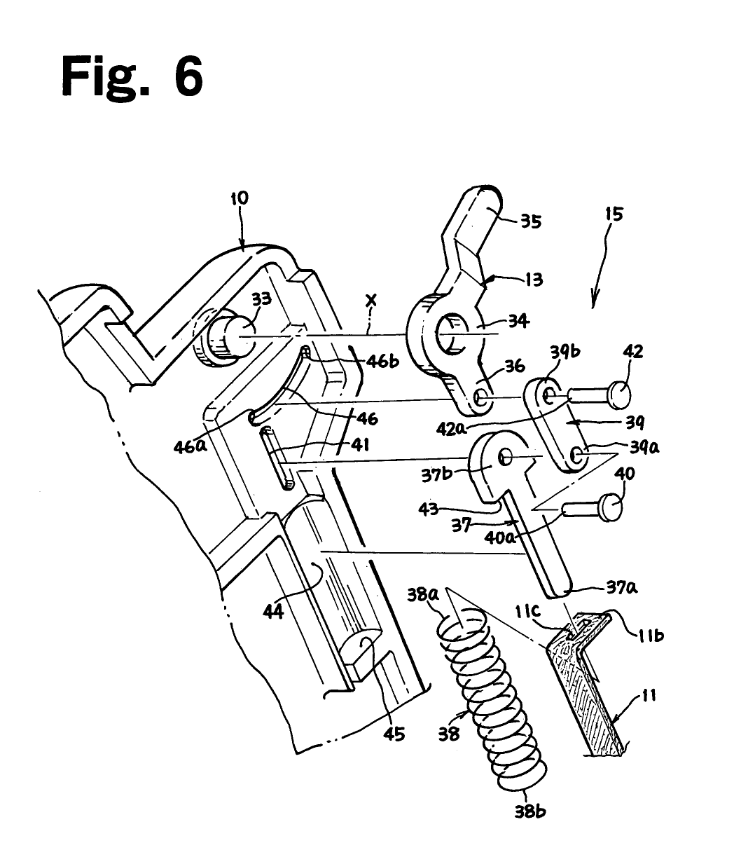

As shown in FIGS. 6 and 7, the brake connector 13 is rotatably attached to a connector shaft 33 formed on the internal surface of the centrifugal clutch cover 10. The brake connector 13 includes a boss 34 mounted on the connector shaft 33 and arms 35 and 36 extending in directions different from each other toward the outside in the radial direction from the boss 34. The operating-side arm 35 is operatively connected to the brake lever 12 while the operated-side arm 36 is operatively connected to the brake band 11.

As shown in FIG. 2, when the brake lever 12 is located at the predetermined neutral position N, the operating-side arm 35 of the brake connector 13 is held in the out-of-contact posture on the normal conditions with the locking mechanism 15 by corresponding thereto. Then, by the swinging of the brake lever 12 on the right F of FIG. 2 (in front of the chain saw 1), the brake connector 13 is clockwise rotated, and is held in a posture during braking shown in FIG. 3 with the locking mechanism 15.

As shown in FIG. 2, the locking mechanism 15 is interposed between the brake connector 13 and the brake band 11. According to the embodiment, the locking mechanism 15 uses an over-dead-center mechanism automatically operating by the rotation of the brake connector 13. The locking mechanism 15 restrains the brake connector 13 in a posture on the normal conditions shown in FIG. 2 and in a posture during braking shown in FIG. 3 and corresponding thereto, restrains the brake band 11 in a brake-cancelled state shown in FIG. 2 and in a braked state shown in FIG. 3.

As shown in FIGS. 6 and 7, the locking mechanism 15 includes a bar-like member 37 operatively connected to the other end 11b of the brake band 11, a locking spring 38 for strongly urging the bar-like member 37 in the braking direction of the brake band 11 along the longitudinal direction of the bar-like member 37, and a link member 39 for connecting between the bar-like member 37 and the brake connector 13. End 37a of the bar-like member 37 is inserted into a slit 11c formed at the upward folded other end 11b of the brake band 11.

One end 39a of the link member 39 is rotatably connected to the other end 37b of the bar-like member 37 with a first pin 40 extending in parallel with the axial line X of the connector shaft 33. The end 40a of the first pin 40 is slidably inserted into a first pin guide groove 41 formed in the internal surface of the centrifugal clutch cover 10 to extend along the longitudinal direction of the bar-like member 37. The other end 39b of the link member 39 is rotatably connected to the operated-side arm 36 of the brake connector 13 to allow rotation with a second pin 42 extending in parallel with the axial line X of the connector shaft 33. The bar-like member 37 is provided with a movable-side spring receiving portion 43 formed adjacent to the other end 37b, at which one end 38a of the compression coil spring 38 is urged in contact with the other end 11b of the brake band 11. The bar-like member 37 inserted into the coil portion of the compression coil spring 38 from the one end 37a side is accommodated within a bar-like member accommodating recess 44 formed on the internal surface of the centrifugal clutch cover 10 together with the compression coil spring 38. The bar-like member accommodating recess 44 is provided with a fixed-side spring receiving portion 45 formed at one end, with which the other end 38b of the compression coil spring 38 is urged in contact. The compression coil spring 38 is interposed between the fixed-side spring receiving portion 45 and the movable-side spring receiving portion 43 in a compressed state so as to constantly urge the bar-like member 37 along its longitudinal direction and a direction straining the brake band 11.

As shown in FIGS. 6 and 7, the centrifugal clutch cover 10 is also provided with a second pin guide groove 46 formed on its internal surface for slidably guiding the end 42a of the second pin 42 as a component of the locking mechanism 15. The second pin guide groove 46 extends in the vertical direction of FIG. 2 along an arc about the axial line X of the connector shaft 33.

As shown in FIG. 2, in a state that the second pin 42 abuts the lower end 46a of the second pin guide groove 46, the second pin 42 is located at a position on the straight line L connecting between the first pin 40 and the axial line X of the connector shaft 33 (dead center line) or a position slightly lower than the dead center line-L. On the other hand, as shown in FIG. 3, in a state that the second pin 42 abuts the upper end 46b of the second pin guide groove 46, the second pin 42 is located at a position upper than the dead center line L. In a state that the second pin 42 abuts the lower end 46a of the second pin guide groove 46, i.e., the brake connector 13 is in the posture on normal conditions of FIG. 2, the brake band 11 becomes the brake-cancelled state. In a state that the second pin 42 abuts the upper end 46b of the second pin guide groove 46, i.e., the brake connector 13 is in the braking posture of FIG. 3, the brake band 11 becomes the braked state.

As described above, when the brake lever 12 is located at the predetermined neutral position N, in accordance with this, the operating-side arm 35 of the brake connector 13 is held in the normal posture of FIG. 2 being out of contact with the brake lever 12. At this time, the link member 39 is also held at the normal position of FIG. 2, at which the second pin 42 abuts the lower end 46a of the second pin guide groove 46, by the urging force of the compression coil spring 38.

As shown in FIG. 7, the one leg 23 of the brake lever 12 is provided with a connector groove 47 formed on the external surface to be a movement groove (swinging groove) of the operating-side arm 35. As shown in FIG. 2, when the brake lever 12 is located at the predetermined neutral position N and the brake connector 13 is in the normal posture, the connector groove 47 and the brake connector 13 are out of contact with each other. Accordingly, during the operation of the chain saw 1, in which the brake lever 12 is located at the predetermined neutral position N, even when the chain saw body 2 vibrates due to the operation of the internal combustion engine 5, fluttering noise cannot be produced between the brake lever 12 and the brake connector 13, and the abrasion problem of the brake connector 13 does not occur. Since the brake connector 13 is out of contact with the brake lever 12 when the brake lever 12 is located at the predetermined neutral position N, there is an advantage that the centrifugal clutch cover 10 having the brake connector 13 attached thereto can be easily put on and taken off the frame for the engine 9 having the brake lever 12 attached thereto.

Next, the operation of the brake system 8 will be described.

During a cutting operation by the chain saw 1 shown in FIG. 1, a so-called kickback phenomenon may occur in that the guide bar 3 is kicked back toward an operator while the chain saw 4 is rotating at high speed as it is by the reaction of the chain saw 4 rotating at the high speed when the end of the guide bar 3 is incidentally brought into contact with an obstacle, such as a tree knot. When such a rapid displacement occurs in the chain saw 1, the brake lever 12 is clockwise swung about the two legs 23 and 24 in the braking direction (in front of the chain saw 1) F viewed in FIG. 2 by the inertia of the brake lever 12 or the relative collision of the back of an operator's hand gripping the handle 16 to the brake lever 12. Then, the rear end 47r of the connector groove 47 abuts the operating-side arm 35 of the brake connector 13, so that the brake connector 13 is clockwise rotated in the one direction F viewed in FIG. 2.

Referring to FIG. 2, at the moment when the second pin 42 is upward moved across the dead center line L by the rotation of the brake connector 13 in the clockwise direction F, the bar-like member 37 instantly moves in the direction pulling the brake band 11 by the urging force of the compression coil spring 38. Thereby, while the first pin 40 is guided by the linear first pin guide groove 41 and the second pin 42 is guided by the circular arc second pin guide groove 46, the link member 39 moves to the braking position shown in FIG. 3 and the brake connector 13 is also displaced to the braking posture shown in FIG. 3. As a result, the other end 11b of the brake band 11 is pulled so that the brake band 11 is changed to the braking state in that the brake band 11 is pressed in contact with the external surface of the clutch drum 6a so as to forcedly stop the rotation of the chain saw 4. Hence, the injury problem of operators does not arise. As shown in FIG. 3, the locking mechanism 15 maintains the brake band 11 in the braked state as well as maintains the link member 39 at the braked position and the brake connector 13 in the braking posture.

As shown in FIG. 3, the torsion spring 14 acts to return the brake lever 12 swinging in the braking direction F to the predetermined neutral position N in the rear direction R. However, once the brake band 11 enters the braking state by the locking. mechanism 15, the brake connector 13 is also restrained in the braking posture, so that the brake lever 12 is held at the position shown in FIG. 3 by the abutment between the operating-side arm 35 of the brake connector 13 and the front end 47f of the connector groove 47 of the brake lever 12.

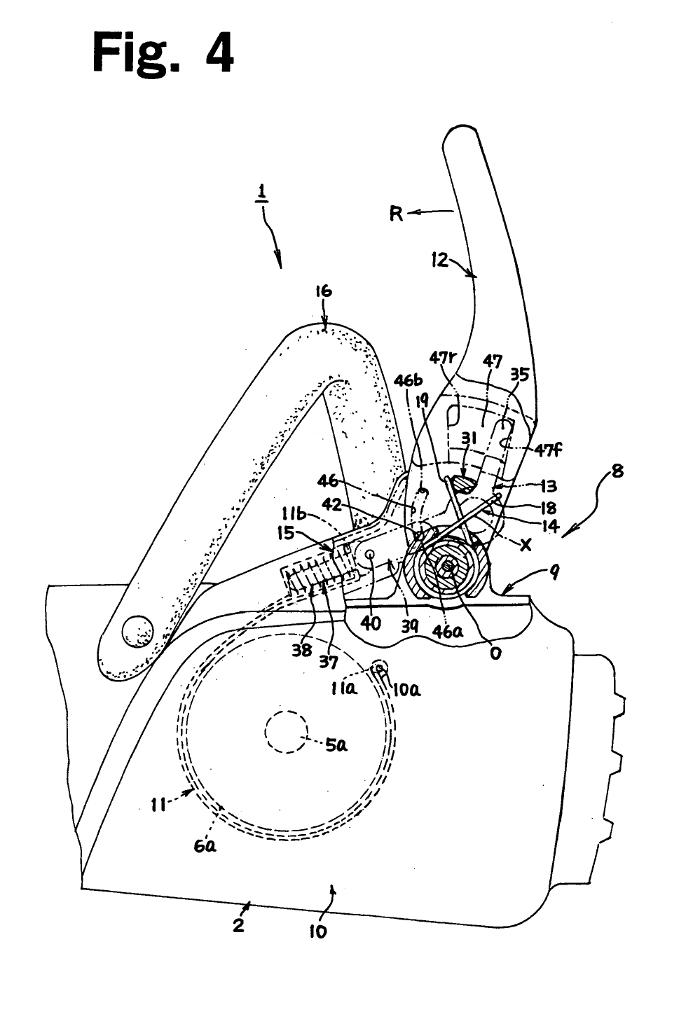

The cancellation of the braking state of the brake band 11 is performed by an operator who swings the brake lever 12 in the rear direction R from the position shown in FIG. 3. That is, in FIG. 3, if the brake lever 12 is largely swung in the rear direction R, the operating-side arm 35 is counterclockwise rotated in the other direction R by being pushed by the front end 47f of the connector groove 47, and the second pin 42 moves until abutment to the lower end 46a of the second pin guide groove 46 while being guided by the second pin guide groove 46. Thereby, the link member 39 also moves to the normal position shown in FIG. 4 while the brake connector 13 is also displaced to the normal posture shown in FIG. 4. As a result, the other end 11b of the brake band 11 is pushed in the rear direction R so that the brake band 11 is changed to the brake-cancelled state in that the brake band 11 is loosened so as to release the clutch drum 6a. The locking mechanism 15 maintains the brake band 11 in the brake-cancelled state shown in FIG. 4 as well as maintains the link member 39 at the normal position of FIG. 4 and the brake connector 13 in the normal posture.

When the operator loses one's grip on the brake lever 12, by the function of the torsion spring 14, the brake lever 12 is automatically returned from the state of FIG. 4 to the predetermined neutral position N shown in FIG. 2 so as to be maintained at that position. Therefore, the operator is not required to confirm whether the brake lever 12 returns to the predetermined neutral position N or not by visual observation, improving operationality.

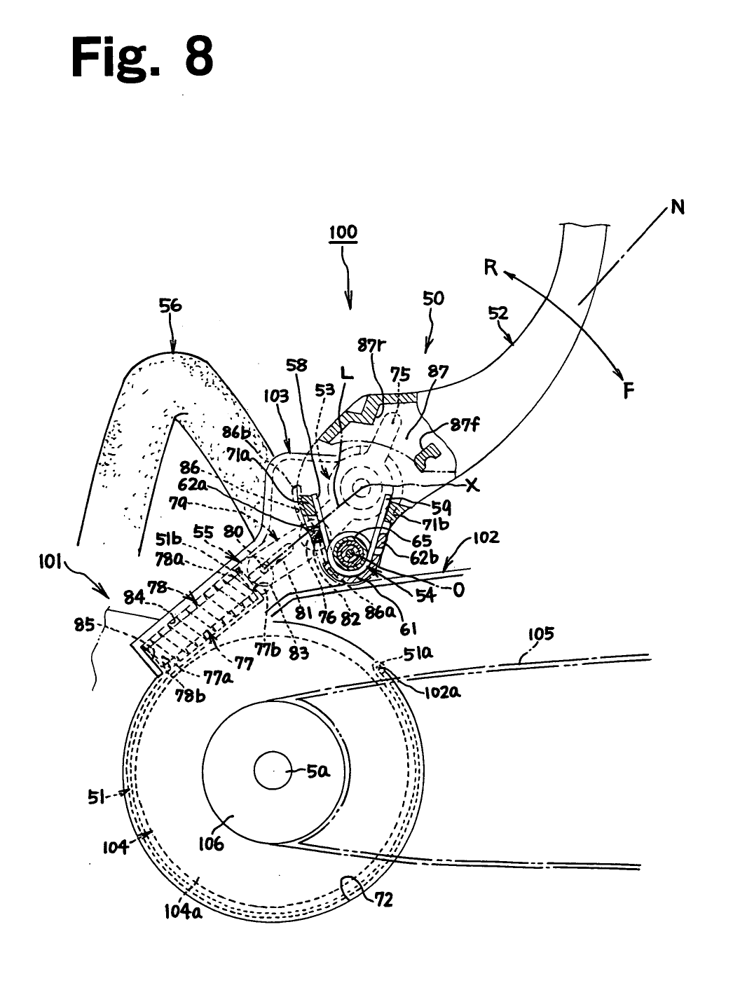

Next, another embodiment of the present invention will be described with reference to FIGS. 8 to 11.

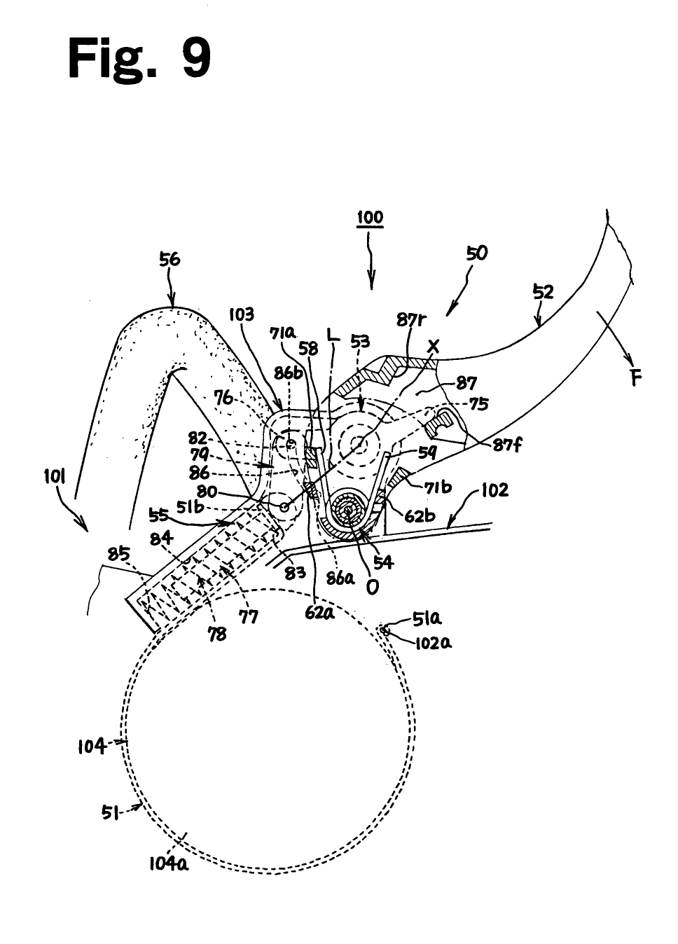

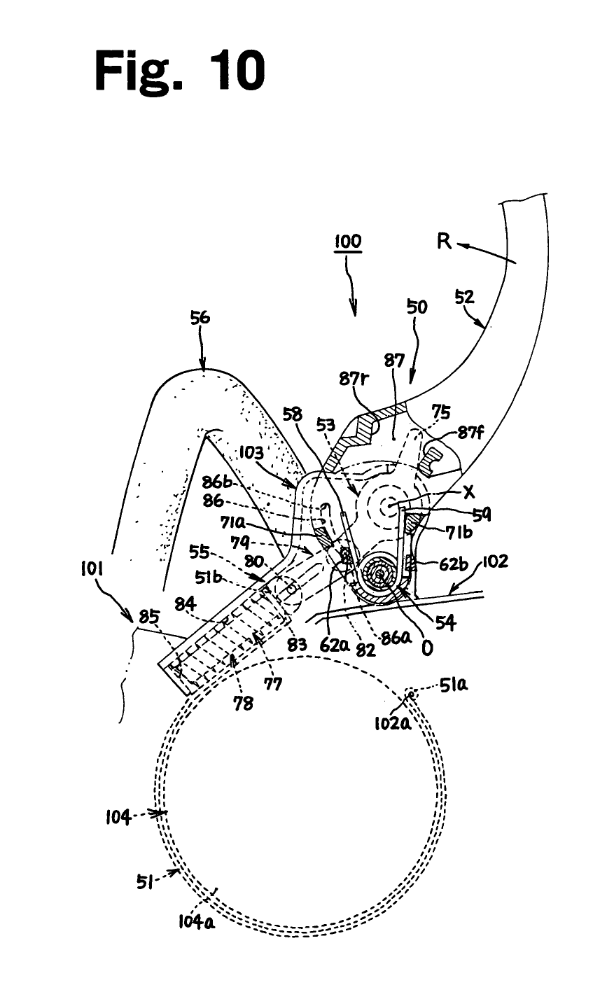

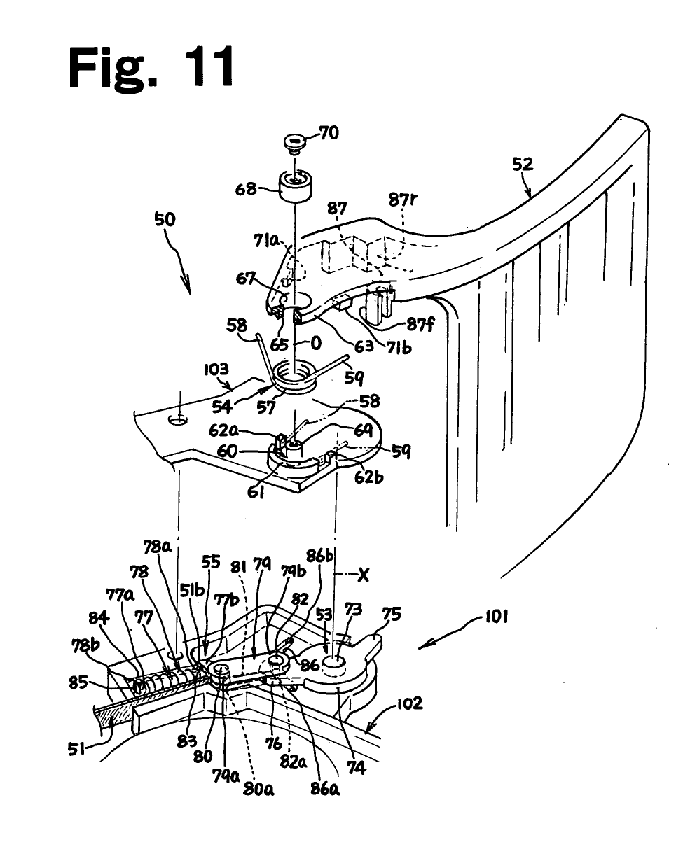

FIG. 8 is a partially broken side view of a brake system according to another embodiment showing a brake-canceled state; FIG. 9 is a partially broken side view showing a braked state due to the brake system of FIG. 8; FIG. 10 is a partially broken side view showing a brake-cancelled state due to the brake system of FIG. 8; and FIG. 11 is an exploded perspective view showing a brake lever mounting structure of the brake system of FIG. 8.

As shown in FIG. 8, this embodiment also incorporates a brake system 50 of a chain saw 100 as a working machine. Conversely to the first embodiment, in a chain saw according to the embodiment, a sprocket 106 for driving a saw chain 105 is fixed on the internal surface, adjacent to the internal combustion engine 5, of a centrifugal clutch 104 coaxially with a clutch drum 104a of the centrifugal clutch 104.

In the same way as the first embodiment, the brake system 50 according to the embodiment also includes a brake band 51 as a brake member, a brake lever 52 for operating the brake band 51, a brake connector 53 for connecting the brake lever 52 to the brake band 51, a lever spring 54 for holding the brake band 51 at a predetermined neutral position N shown in FIG. 8 as an urging member, and a locking mechanism 55 for holding the brake band 11 in a braked state and in a brake-cancelled state.

According to the embodiment, any of the brake band 51, the brake connector 53, and the locking mechanism 55 can be assembled on the external surface of a crankcase (an extension wall adjacent to the output of the engine) 102 as a first member constituting a chain saw body 101 of the chain saw 100. The brake lever 52 and the lever spring 54 are attached to a connector cover 103 detachably fixed to the crankcase 102 as a second member. Upon assembling of the chain saw 100, the brake band 51, the brake connector 53, and the locking mechanism 55 are attached on the external surface of the crankcase 102. Then, after the connector cover 103 is attached on the crankcase 102, the lever spring 54 and one leg 63 of the brake lever 52 are attached on the connector cover 103.

First, members attached on the external surface of the crankcase 102, those are, the brake band 51, the brake connector 53, and the locking mechanism 55, will be described.

As shown in FIG. 8, the brake band 51 is wound around the external surface of the clutch drum 104a, with one end 51a joined on the crankcase 102 with a retainer pin 102a and with the other end 51b connected to the brake connector 53 via the locking mechanism 55. On the internal surface of the crankcase 102, a cylindrical clutch drum accommodating recess 72 is formed to correspond to the clutch drum 104a, and the brake band 51 is arranged along the internal surface of the clutch drum accommodating recess 72 so as to be slightly press-bonded thereon. Thus, when the centrifugal clutch 104 is attached to the output shaft Sa of the internal combustion engine (not shown) protruding from the crankcase 102, between the external surface of the clutch drum 104a and the internal surface of the clutch drum accommodating recess 72, the brake band 51 is naturally located slightly apart from the external surface of the clutch drum 104a. When the brake lever 52 is located at the predetermined neutral position N, in accordance with this, the brake band 51 is in a brake-cancelled state in that the clutch drum 104a is not braked. By the swinging of the brake lever 52 in the brake operating direction on the right F of FIG. 8 (in front of the chain saw 100), as shown in FIG. 9, the state is changed to the braking to be press-bonded on the external surface of the clutch drum 104a.

As shown in FIG. 11, the brake connector 53 is rotatably fixed to a connector shaft 73 formed on the external surface of the crankcase 102. The brake connector 53 includes a boss 74 mounted on the connector shaft 73 and arms 75 and 76 extending in directions different from each other outward in the radial direction from the boss 74. The operating-side arm 75 is operatively connected to the brake lever 52 while the operated-side arm 76 is operatively connected to the brake band 51.

As shown in FIG. 8, when the brake lever 52 is located at the predetermined neutral position N, the operating-side arm 35 of the brake connector 53 is held in an out-of-contact posture on the normal conditions with the locking mechanism 55 by corresponding thereto. Then, by the swinging of the brake lever 52 on the right F of FIG. 2 (in front of the chain saw 100), the brake connector 53 is clockwise rotated, and is held in a posture during braking shown in FIG. 9 with the locking mechanism 55.

As shown in FIG. 8, the locking mechanism 55 is interposed between the brake connector 53 and the brake band 51. According to the embodiment, the locking mechanism 55 uses an over-dead center mechanism automatically operated by the rotation of the brake connector 53. The locking mechanism 55 restrains the brake connector 53 in a posture on the normal conditions shown in FIG. 8 and in a posture during braking shown in FIG. 9 while by corresponding thereto, restrains the brake band 51 in a brake-cancelled state shown in FIG. 8 and in a braked state shown in FIG. 9.

As shown in FIG. 11, the locking mechanism 55 includes a bar-like member 77 operatively connected to the other end 51b of the brake band 51, a locking spring 78 for strongly urging the bar-like member 77 in the braking direction of the brake band 51 along the longitudinal direction of the bar-like member 77, and a link member 79 for connecting between the bar-like member 77 and the brake connector 53. One end 77a of the bar-like member 77 is inserted into a slit (not shown) formed at the upward folded other end 51b of the brake band 51.

One end 79a of the link member 79 is rotatably connected to the other end 77b of the bar-like member 77 with a first pin 80 extending in parallel with the axial line X of the connector shaft 73. The end 80a of the first pin 80 is slidably inserted into a first pin guide groove 81 formed in the external surface of the crankcase 102 to extend along the longitudinal direction of the bar-like member 77. The other end 79b of the link member 79 is rotatably connected to the operated-side arm 76 of the brake connector 53 with a second pin 82 extending in parallel with the axial line X of the connector shaft 73. The bar-like member 77 is provided with a movable-side spring receiving portion 83 formed adjacent to the other end 77b, at which one end 78a of the compression coil spring 78 is urged in contact with the other end 51b of the brake band 51. The bar-like member 77, inserted into the coil portion of the compression coil spring 78 at the side of one end 77a, is accommodated within a bar-like member accommodating recess 84 formed on the external surface of the crankcase 102 together with the compression coil spring 78. The bar-like member accommodating recess 84 is provided with a fixed-side spring receiving portion 85 formed at one end, with which the other end 78b of the compression coil spring 78 is urged in contact. The compression coil spring 78 is interposed between the fixed-side spring receiving portion 85 and the movable-side spring receiving portion 83 in a compressed state so as to constantly urge the bar-like member 77 along its longitudinal direction and a direction straining the brake band 51.

As shown in FIG. 11, the crankcase 102 is also provided with a second pin guide groove 86 formed on its external surface for slidably guiding the end 82a of the second pin 82 as a component of the locking mechanism 55. The second pin guide groove 86 extends in the vertical direction of FIG. 8 along an arc about the axial line X of the connector shaft 73.

As shown in FIG. 8, in a state that the second pin 82 abuts the lower end 86a of the second pin guide groove 86, the second pin 82 is located at a position on the straight line L connecting the first pin 80 and the center X of the connector shaft 73 (dead center line) or a position slightly lower than the dead center line L. On the other hand, as shown in FIG. 9, in a state that the second pin 82 abuts the upper end 86b of the second pin guide groove 86, the second pin 82 is located at a position above the dead center line L. In a state that the second pin 82 abuts the lower end 86a of the second pin guide groove 86, i.e., the brake connector 53 is in the posture on normal conditions of FIG. 8, the brake band 51 becomes the brake-cancelled state. In a state that the second pin 82 abuts the upper end 86b of the second pin guide groove 86, i.e., the brake connector 53 is in the braking posture of FIG. 9, the brake band 51 becomes the braked state.

As shown in FIG. 11, to the crankcase 102, after assembling the brake connector 53, the locking mechanism 55, and the brake band 51 thereto, the connector cover 103 is attached for covering at least the brake connector 53 and the locking mechanism 55.

Next, the brake lever 52 and the lever spring 54 will be described.

As shown in FIG. 8, the one leg 63 of the brake lever 52 is supported to the connector cover 103 swingably in the front-rear direction F-R, and on the normal conditions, the one leg 63 is maintained at the predetermined neutral position N shown in FIG. 8 by the lever spring 54. According to the embodiment, the state of FIG. 8 when the brake lever 52 is naturally raised in front of a front handle 56 of the chain saw 100 is defined to be the predetermined neutral position N.

The lever spring 54 maintains the brake lever 52 at the predetermined neutral position N, and if the brake lever 52 is displaced in the front-rear direction F-R of the chain saw 100, the lever spring 54 always acts to return the brake lever 52 to the predetermined neutral position N.

As shown in FIG. 11, according to the embodiment, a torsion spring is used for the lever spring 54, and this torsion spring is arranged between the connector cover 103 and the brake lever 52 coaxially with the swinging center Q of the brake lever 52. Thus, the arrangement space for the lever spring 54 can be reduced as small as possible, enabling the machine to be compact.

The torsion spring 54 includes a wound ring portion 57 and two angular portions 58 and 59 continuously disposed to the wound ring portion 57, each broadening toward its end. As shown in FIG. 11 with phantom lines, the spring is held to have a posture corresponding to the predetermined neutral position N by crosswise gathering the two angular portions 58 and 59 so as to be fitted into an intrusion portion 60 formed on the connector cover 103 in a state that a springing force is stored. The spring intrusion portion 60 includes a circular arc projection 61 curved in a shape corresponding to the ring portion 57 of the lever spring 54, and spring restriction portions 62a and 62b formed on upper both ends of the circular arc projection 61, respectively. When the ring portion 57 is fitted into the circular arc projection 61 by gathering the two angular portions 58 and 59 together, the two angular portions 58 and 59 abut the restriction portions 62a and 62b, respectively, by the springing force of the torsion spring 54, so that the restriction portions 62a and 62b restrict the further opening of the two angular portions 58 and 59.

After fitting the torsion spring 54 into the spring intrusion portion 60, the brake lever 52 is attached on the connector cover 103. The brake lever 52 includes a leg 63 for attaching the brake lever 52 to the chain saw body 101. The brake lever 52 is provided with a cylindrical projection 65 integrally formed coaxially with the spring intrusion portion 60 on the internal surface of the leg 63. The cylindrical projection 65 acts as a spring intrusion portion of the brake lever 52 and has an external surface with a size just fitting the internal surface of the ring portion 57. Hence, after fitting the torsion spring 54 into the spring intrusion portion 60, when the other leg (not shown), from thereon, is brought into engagement with an engagement portion (not shown) formed on the other side of the chain saw body 101, and the leg 63 is coaxially overlapped thereon, the cylindrical projection 65 is fitted into the internal surface of the ring portion 57. Then, from the outside of the leg 63, by attaching an anti-slipping cylinder 68 rotatably fitting into a through hole 67 formed coaxially with the cylindrical projection 65 and a mounting screw 70 inserted into the anti-slipping cylinder 68 and screwed into a screw hole 69 formed at the center of the spring intrusion portion 60 to the leg 63, the torsion spring 54 is clamped between the connector cover 103 and the brake lever 52 and the mounting of the brake lever 52 on the chain saw body 101 including the connector cover 103 in a manner that allows it to swing in the front-rear direction is completed.

The brake lever 52 is provided with spring receiving portions 71a and 71b formed to be respectively joined on the two angular portions 58 and 59 of the torsion spring 54. The brake lever 52 is attached to the connector cover 103 at an angular position (the predetermined neutral position N), at which the torsion spring 54 having the spring posture on normal conditions is finely joined to the spring receiving portions 71a and 71b. According to the embodiment, the spring receiving portions 71a and 71b are formed to protrude at positions slightly upper than the cylindrical projection 65 on the internal surface of the leg 23. Ends of the two angular portions 58 and 59 of the torsion spring 54, which protrude upward across the spring restriction portions 62a and 62b formed on the connector cover 103, abut the spring receiving portions 71a and 71b, respectively (see FIG. 8). Accordingly, the torsion spring 54 maintains the brake lever 52 at the predetermined neutral position N such that when a hand is freed after displacing the brake lever 52 in the front-rear direction F-R of the handle 56 from the predetermined neutral position N, acts to automatically return the brake lever 52 to the predetermined neutral position N.

Referring to FIG. 11, conversely to the above-description, using the cylindrical projection 65 and the spring receiving portions 71a and 71b, at first, the torsion spring 54 is attached to the brake lever 52 in the spring posture on normal conditions, and then, the brake lever 52 in this state may be obviously attached to the connector cover 103.

As shown in FIGS. 8 and 11, the leg 63 of the brake lever 52 is provided with a connector groove 87 formed on the internal surface to be a movement groove (swinging groove) of the operating-side arm 75. As shown in FIG. 8, when the brake lever 52 is located at the predetermined neutral position N and the brake connector 53 is in the normal posture, the connector groove 47 and the brake connector 53 are out of contact with each other. Accordingly, during the operation of the chain saw 100, in which the brake lever 52 is located at the predetermined neutral position N, even when the chain saw body 101 vibrates due to the operation of the internal combustion engine (not shown), fluttering noise cannot be produced between the brake lever 52 and the brake connector 53, and the abrasion problem of the brake connector 53 does not occur.

Next, the operation of the brake system 50 will be described.

During cutting operation by the chain saw 100, if the chain saw 100 is kicked back toward an operator due to a so-called kickback phenomenon, the brake lever 52 is clockwise swung about the leg 63 in the braking direction (in front of the chain saw 100) F viewed in FIG. 8 by the inertia of the brake lever 52 or the relative collision of the back of an operator's hand gripping the handle 56 to the brake lever 52. Then, the rear end 87r of the connector groove 87 abuts the operating-side arm 75 of the brake connector 53, so that the brake connector 53 is clockwise rotated in the one direction F viewed in FIG. 8.

Referring to FIG. 8, at the moment when the second pin 82 is moved upward across the dead center line L by the rotation of the brake connector 53 in the clockwise direction F, the bar-like member 77 instantly moves in the direction pulling the brake band 51 by the urging force of the compression coil spring 78. Thereby, while the first pin 80 is guided by the linear first pin guide groove 81 and the second pin 82 is guided by the circular arc second pin guide groove 86, the link member 79 moves to the braking position shown in FIG. 9 and the brake connector 53 is also displaced to the braking posture shown in FIG. 9. As a result, the other end 51b of the brake band 51 is pulled so that the brake band 51 is changed to the braking state in that the brake band 51 is pressed in contact with the external surface of the clutch drum 104a so as to forcedly stop the rotation of the chain saw 105. Hence, the injury problem of operators does not arise. As shown in FIG. 9, the locking mechanism 55 maintains the brake band 51 in the braked state as well as maintains the link member 79 at the braked position and the brake connector 53 in the braking posture.

As shown in FIG. 9, the torsion spring 54 acts to return the brake lever 52 swinging in the braking direction F to the predetermined neutral position N in the rear direction R; however, if the brake band 51 once becomes the braking state, by the locking mechanism 55, the brake connector 53 is also restrained in the braking posture, so that the brake lever 52 is held at the position shown in FIG. 9 by the abutment between the operating-side arm 75 of the brake connector 53 and the front end 87f of the connector groove 87 of the brake lever 52.

The cancellation of the braking state of the brake band 51 is performed by the operator who swings the brake lever 52 in the rear direction R from the position shown in FIG. 9. That is, in FIG. 9, if the brake lever 52 is swung greatly in the rear direction R, the operating-side arm 75 is counterclockwise rotated in the other direction R by being pushed by the front end 87f of the connector groove 87, and the second pin 82 moves until it abuts the lower end 86a of the second pin guide groove 86 while being guided by the second pin guide groove 86. Thereby, the link member 79 also moves to the normal position shown in FIG. 10 while the brake connector 53 is displaced to the normal posture shown in FIG. 10. As a result, the other end 51b of the brake band 51 is pushed in the rear direction so that the brake band 51 is changed to the brake-cancelled state in that the brake band 51 is loosened so as to release the clutch drum 104a. The locking mechanism 55 maintains the brake band 51 in the brake-cancelled state shown in FIG. 10 as well as maintains the link member 79 at the normal position of FIG. 10 and the brake connector 53 in the normal posture.

When the operator loses one's grip on the brake lever 52, by the function of the torsion spring 54, the brake lever 52 is automatically returned from the state of FIG. 10 to the predetermined neutral position N shown in FIG. 8 so as to be maintained at that position. Therefore, the operator is not required to confirm whether the brake lever 52 returns to the predetermined neutral position N or not by visual observation, improving operationality.

What is claimed is:

1. A brake system of a working machine comprising:
a braking member for braking an operating member mounted on a working machine body;
a brake lever for operating the braking member;
a brake connector for operatively connecting the brake lever to the braking member;
an urging member that maintains the brake lever at a predetermined neutral position and constantly acts to return the brake lever to the predetermined neutral position if the brake lever is displaced from the predetermined neutral position; and
a locking mechanism operated by the displacement of the brake connector so as to maintain the braking member in a braked state or in a brake-cancelled state,
wherein when the brake lever is located at the predetermined neutral position, and the brake lever and the brake connector are out of contact with each other,
wherein by the displacement of the brake lever in a braking direction from the predetermined neutral position, the brake connector is driven in one direction and the braking member is maintained in the braked state by the locking mechanism, and
wherein by the displacement of the brake lever in a brake-canceling direction, the brake connector is driven in another direction and the braking member is maintained in the brake-canceled state by the locking mechanism.

2. The system according to claim 1, wherein the urging member includes a torsion spring arranged about a swinging center of the brake lever.

3. The system according to claim 1, wherein the working machine body includes a first member and a second member attached to the first member, and
wherein the brake lever is attached to the first member in a manner that allows the brake lever to swing; the urging member is interposed between the first member and the brake lever; and the braking member and the brake connector are assembled to the second member.

4. The system according to claim 3, wherein the first member includes a frame for an internal combustion engine; the operating member includes a centrifugal clutch drivingly connected to the internal combustion engine; and the second member includes a centrifugal clutch cover.

5. The system according to claim 1, wherein the working machine body includes a first member and a second member attached to the first member, and
wherein the brake lever is swingably attached to the second member; the urging member is interposed between the second member and the brake lever; and the braking member and the brake connector are assembled to the first member.

6. The system according to claim 5, wherein the first member includes a crankcase of an internal combustion engine and the second member includes a cover of the locking mechanism.

7. The system according to claim 1, wherein the locking mechanism includes an over dead center mechanism interposed between the brake connector and the braking member.
